(19) United States
(12) Patent Application Publication
(10) Pub. No.: US 2004/0007621 A1
(43) Pub. Date: Jan. 15, 2004

(54) Code reader

(75) Inventor: Tohru Okada, Aichi-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN ENGINEERING CO., LTD., Kariya (JP)

(21) Appl. No.: 10/447,994

(22) Filed: May 30, 2003

(30) Foreign Application Priority Data
May 30, 2002 (JP) 2002-195251
Nov. 29, 2002 (JP) 2002-382825

(51) Int. Cl. G06K 7/10; G06K 7/14

(52) U.S. Cl. 235/454

(57) ABSTRACT

A code reader which includes a housing; a reading portion, provided on the housing, for reading a code provided on an object; an illumination device provided in the housing; an image capturing device, provided in the housing, for imaging the code, the illumination device irradiating light to a surface to be read provided with the code reflecting the irradiated light, the image capturing device configured to be entered with the reflected light via an entrance pupil provided in the housing, the image capturing device being configured to read information of the code, a diffusion member for permeating and diffusing the light from the illumination device and for irradiating the diffused light to the surface to be read, the plural illumination device positioned opposite each other relative to the entrance pupil, and the diffusion member positioned between the illumination device and the reading portion.

### CROSS-REFERENCE TO RELATED APPLICATIONS

This application is based on and claims priority under 35 U.S.C. § 119 to Japanese Patent Application No. 2002-195251 filed on May 30, 2002, and Japanese Patent Application No. 2002-382825 filed on Nov. 29, 2002, the entire contents of which are incorporated herein by reference.

### BACKGROUND OF THE INVENTION

1. Field of the Invention

The present invention relates to a code reader. More specifically, the present invention pertains to an internal construction of a code reader for reading a code (i.e., unique information such as a one-dimensional code, a two-dimensional code, a three-dimensional code, a hybrid multi-dimensional code combining different codes that show the unique information for an object, and the like) based on a reflection of irradiated light.

2. Description of the Related Art

In order to control particular objects (e.g., products), for purposes such as inventory, each object may provided with a code for differentiating each product. By reading the code provided on the particular product with a code reader, the product may be comprehensively controlled.

A code reader described in Japanese Patent Laid-Open Publication No. 2001-160115 includes a lens and a sensor provided on a top portion of a body of the code reader, a reading portion provided on a bottom portion of the code reader, and a plurality of light sources opposingly positioned on an internal peripheral surface of the reading portion. With the code reader described in Japanese Patent Laid-Open Publication No. 2001-160115, the light from the light sources is irradiated on a surface to be read provided with a code by positioning the plural light sources on the internal peripheral surface of the reading portion.

With the code reader described in Japanese Patent Laid-Open Publication No. 2001-160115, the surrounding of the lens for entering the reflective light to the sensor is brightly illuminated because the plural light sources are opposingly provided. However, the illumination of the surface to be read is performed by utilizing an expanse of an irradiation angle of the light from the light sources. Thus, the longer a distance between the reading portion and the surface to be read, the more difficult it is for the light from the light sources to reach the surface to be read. Accordingly, efficient irradiation of light is not performed with the foregoing construction for illuminating the surface to be read. Therefore, the surface to be read remains dark with the foregoing construction, thereby making the recognition of the code difficult.

In addition, with the code reader described in Japanese Patent Laid-Open Publication No. 2001-160115, the light generated by the light source is unlikely to be uniformly irradiated relative to the surface to be read. The brightness of the generated light is uneven, which negatively affects the code reading.

A need thus exists for a code reader which brightly illuminates a surface to be read and facilitates the code recognition by irradiating a more even light to the surface to be read.

### SUMMARY OF THE INVENTION

In light of the foregoing, the present invention provides a code reader that includes a housing; a reading portion, provided on the housing, for reading a code provided on an object; an illumination means provided in the housing; an image capturing means, provided in the housing, for imaging the code; the illumination means irradiating light to a surface to be read; the image capturing means configured to receive the reflected light via an entrance pupil provided in the housing; the image capturing means configured to read information of the code; a diffusion member for permeating and diffusing the light from the illumination means and for irradiating the diffused light to the surface to be read; the plural illumination means being positioned opposite to each other relative to the entrance pupil, and the diffusion member being positioned between the illumination means and the reading portion.

According to another aspect of the present invention, a code reader includes a housing; a reading portion, provided on the housing, for reading a code provided on an object; a light source, provided in the housing, configured to irradiate light to a surface to be read; a CCD camera, provided in the housing, configured to image the code via an entrance pupil provided in the housing; a diffusion member configured to permeate and to diffuse the light from the light source and to irradiate the diffused light to the surface to be read, the plural light source positioned opposing each other relative to the entrance pupil, and the diffusion member positioned between the light source and the reading portion.

### BRIEF DESCRIPTION OF THE DRAWINGS

The foregoing and additional features and characteristics of the present invention will become more apparent from the following detailed description, when considered with reference to the accompanying drawing figures, in which like reference numerals designate like elements.

FIG. 1 is an overview showing a configuration of a code reader according to a first embodiment of the present invention.

FIG. 2 is a cross-sectional view (i.e., view from the right side on the X-Y plane) of the code reader of FIG. 1.

FIG. 3 is a cross-sectional view (i.e., view from the left side on the X-Y plane) of the code reader of FIG. 1.

FIG. 4 is a cross-sectional view of a hood portion on the X-Z plane of FIG. 1.

FIG. 5 is a view showing an internal construction removed with a housing on a back surface from the code reader of FIG. 1.

FIG. 6 is a view showing an internal construction removed with a main board and an optical board from FIG. 5.

FIG. 7 is a back view of the housing of the code reader of FIG. 1.

FIG. 8 is a side view showing a construction of an illumination unit provided in the code reader of FIG. 1.

FIG. 9 is a cross-sectional view on the X-Y plane showing an internal construction of the illumination unit shown in FIG. 8.

FIG. 10 is an explanatory view for indicating a reading range when performing the code reading of a unique code with the code reader of FIG. 2.

FIG. 11 is a view showing a configuration of a two-dimensional code provided on an object shown in FIG. 10.

FIG. 12 is an explanatory view showing an expansion of the light when the light is irradiated from the illumination unit to the surface to be read.

FIG. 13 is a perspective view showing a configuration of a diffusion sheet shown in FIG. 12.

FIG. 14 is a perspective view showing a configuration of a diffusion sheet according to a second embodiment of a code reader of the present invention.

### DETAILED DESCRIPTION OF THE PREFERRED EMBODIMENTS

An embodiment of a code reader according to the present invention will be explained with reference to the illustrations of the drawing figures.

A code reader 1 is configured to read the information about an object 30 from a code 10 (e.g., a one-dimensional code, a two-dimensional code, a three-dimensional code, or a multi-dimensional code combined with different codes, and the like, hereinafter referred to as a code) by providing the code 10 directly or indirectly on the object in order to identify the particular object 30 among plural objects made of metal, rubber, ceramic, and resin, or the like. With the code reader according to this non-limiting embodiment, a two-dimensional code may be applied and the code reader 1 for reading the information shown with the two-dimensional code will be explained.

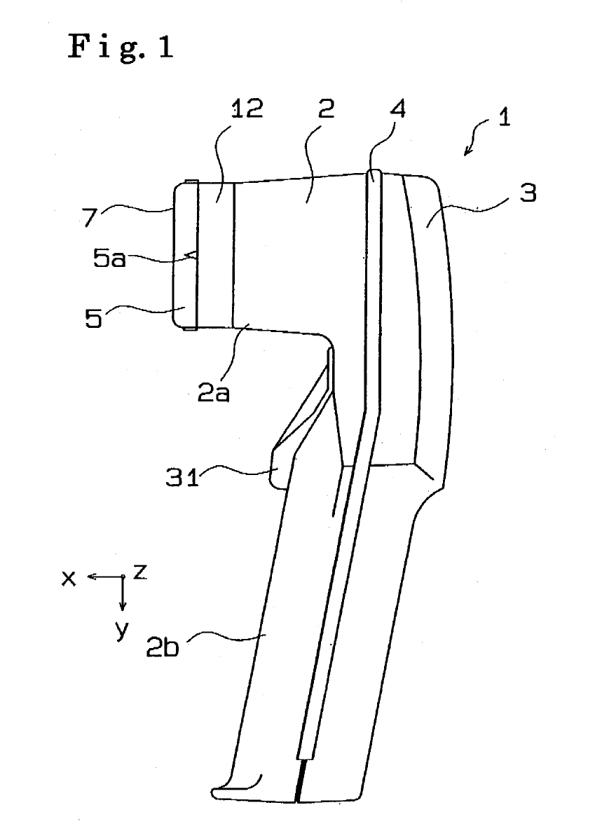

With the present embodiment of the code reader, a light axis direction perpendicular to a CCD (charge coupled device) element included in a CCD camera 95 and lens group 91 is determined to be an X-axis direction. A direction perpendicular to the X-axis is determined to be a Y-axis direction, and a direction perpendicular to the X-axis and the Y-axis is determined to be a Z-axis direction. Further, a top of the code reader 1 shown in FIG. 1 is determined to be a top of the code reader, a bottom of FIG. 1 is determined to be a bottom of the code reader 1, and a right side of FIG. 1 is determined to be a back surface of the code reader 1.

As shown in the non-limiting illustration of FIG. 1, the code reader 1 includes a first housing 2 and a second housing 3 made of resin or the like. Non-limiting examples of a suitable material include ABS resin and urethane. The first housing 2 may be formed with an opening on the back surface (i.e., right side of FIG. 1) and the opening may be covered with the second housing 3 having a recessed configuration. The top of the reader of the first housing 2 may be unitarily formed with a hood portion 2a having an approximately rectangular configuration projected in the X-direction. A grip portion 2b may be formed to be extended slightly tilted from the Y-axis shown in FIG. 1 at an acute angle from the hood portion 2a of the first housing 2. The first and the second housings 2,3 may be assembled for covering the openings formed respectively and may be fixed each other with tightening members such as screws or the like.

The code reader 1 includes an operation lever 31, provided between the hood portion 2a and the grip portion 2b of the housing 2, rotatable about the Z-axis. By the operation of the operation lever 31 by a user, the code reader 1 is activated to read the code 10 provided on the object 30.

When the first and the second housings 2, 3 are assembled to be fixed, a slip stopper 4 made of, for example, rubber or elastomer or the like may be provided, and may be configured to correspond to the opening configurations of the housings 2, 3. The slip stopper 4 is secured to the first and the second housings 2, 3, along the configuration of the opening end portions of the housings 2, 3 provided between the housings 2, 3. The slip stopper 4 prevents the slip of a hand from the grip portion 2b when the user operates the operation lever 31 of the code reader 1 for reading the code 10.

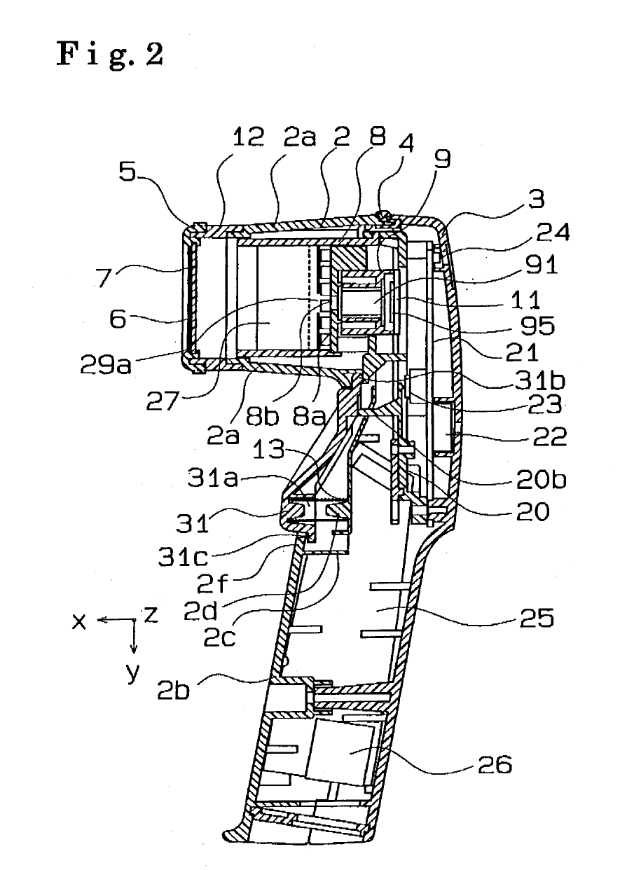

Referring to FIG. 2, the internal construction of the code reader 1 and positions of. parts will be explained. The hood portion 2a of the housing 2 opens in the X-direction. An adjusting member 12 for optically adjusting the reading distance is fitted at an end of the opening of the hood portion 2a. The adjusting member 12 includes a configuration the same with the end of the opening of the hood portion 2a and may be made of the same material with the housing 2. A hood cover (cap) 5 including a light permeation plate, for example, transparent or semi-transparent glass or plastic or the like processed as the optical filter, and functioning as an optical filter for cutting the ultraviolet rays and infrared rays, may be provided on a tip end of the adjusting member 12. The hood cover 5 made of rubber or elastomer or the like may be provided on one end of the adjusting member 12 provided on the hood portion 2a along the configuration of the opening of the adjusting member 12 corresponding to the opening of the hood portion 2a.

Four position determination portions 5a for facilitating the positioning in the Y-direction and the Z-direction between the code 10 and a surface of the code 10 to be read may be formed unitarily on the hood cover 5. The position determination portion 5a has a triangular configuration at the center in the Y-direction and the Z-direction of the hood cover 5 having approximately rectangular configuration. A surface covered with the hood cover 5 corresponds to a reading portion 7 for reading the code 10 and a surface to be read for reading the code 10 is located outside from the reading portion 7. In the hood portion 2a, an illumination unit 8 configured to illuminate the surface 32 to be read may be provided in an inner part of the reading portion 7.

The illumination unit 8 including an opening 8e on the reading portion 7 side may be configured to be a box shape with a bottom and may be made of a resin or the like. The illumination unit 8 may be provided with light sources 18 for illumination for illuminating the surface 32 to be read by generating a colored light (e.g., red) on both sides of a back surface internal wall relative to the X-direction. The internal wall of the illumination unit 8 may be coated with a camouflaged color (i.e., the surface has a color that reflects light, for example, white) or may be molded with a resin or the like having a camouflaged color in order to reflect the light generated from the light source 18 for illumination in the illumination unit 8. In this case, the internal wall of the illumination unit 8 may have a mirror surface or may be coated with a mirror surface or the like, instead of being coated with a camouflage color. A diffusion member 27 may be provided between the reading portion 7 and the light source 18 in the illumination unit 8 for diffusing the light generated by the light source 18 when the light passes therethrough. Additionally, the diffusion member may irradiate the efficiently diffused light (i.e., diffused light) to the surface 32 to be read.

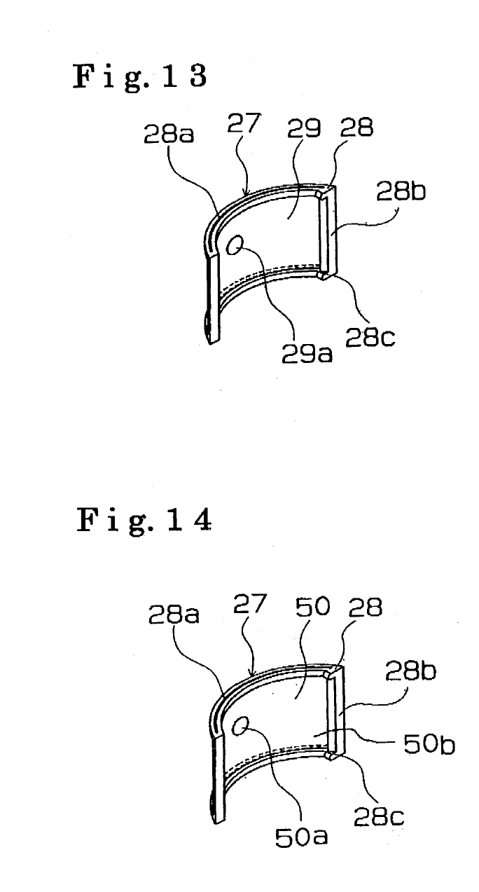

As shown in FIG. 13, the diffusion member 27 including a curved configuration may be formed with a bore 29a in the center portion thereof for entering the reflective light reflected by contacting the code 10 to the CCD camera 95. The diffusion member 27 includes a diffusion sheet 29 for diffusing the entered light and a sheet frame (protection frame) 28 configured to be fitted with the diffusion sheet 29 to be positioned at a predetermined position in the illumination unit 8. The diffusion sheet 29 may be made of white semi-transparent polyester or polycarbonate or the like, having a thickness of several millimeters (e.g., about 0.1-0.2 mm; more preferably, about 0.15 mm). The permeability may be approximately 75-85 percent.

The sheet frame 28 may also include a configuration for protecting the diffusion sheet 29 from damage by impact and may be made of ABS resin, polypropylene resin, nylon system, or elastomer, or the like. The sheet frame 28 is elastically deformable and the diffusion sheet 29 may be positioned therein. More specifically, an insertion opening 28a for inserting and accommodating the diffusion sheet 29 by sandwiching the diffusion sheet 29 may be formed on one side (i.e., top of FIG. 13) of the sheet frame 28. By inserting the diffusion sheet 29 from the insertion opening 28a, the diffusion sheet 29 can be positioned in the illumination unit 8 while the periphery of the diffusion sheet 29 is supported by the sheet frame 28. In other words, the diffusion sheet 29 is replaceable, and a diffusion sheet having at least one of a constant or varying thickness may be used. In case the diffusion sheet 29 is deteriorated or damaged by aging or wear, the diffusion sheet 29 can be removed from the sheet frame 28 to be replaced. The sheet frame 28 is also removeable. In order to facilitate the replacement of the diffusion sheet 29 from the opening 8e of the illumination unit 8 of the diffusion member 27, a rib 28c inwardly projecting is formed as one unit with the sheet frame 28 on both end portions 28b in the Y-direction on the sheet frame 28.

The diffusion light may be generated by the diffusion member 27 in the illumination unit 8 by positioning the diffusion member 27 with the foregoing construction in the illumination unit 8. In this case, the diffusion light is evenly generated within a region illustrated with dotted line of FIG. 12.

A bore (entrance pupil) 8b may be formed on a bottom portion 8a of the illumination unit 8. The bore 8b may be provided facing the bore 29a formed on the diffusion sheet 29, and may function as an entrance pupil for restricting the light relative to the CCD element of the CCD camera 95 when the image is imaged using the reflective light. Two slit bores 8c are formed on the bottom portion 8a on both sides of the bore 8b formed in the center portion. The slit bore 8c allows the light from a marker light source (marker LED) 94 to pass through the colored light (e.g. red) to the surface 32 to be read.

In this case, provided that a minimum distance in the X-direction between the light source 18 and the diffusion sheet 29 of the diffusion member 27 is determined as a minimum distance La and a minimum distance in the X-direction between the bore 8b functioning as the entrance pupil and the diffusion sheet 29 is determined as a minimum distance Lb, the minimum distance La is greater than the minimum distance Lb. The distance between the diffusion sheet 29 and the bottom portion 8a of the illumination unit 8 is gradually increased when shifting from the position of the bore 8b from the center portion to the outward direction in the Z-direction. The minimum distances La, Lb correspond to the distance in the X-direction.

An optical unit 9 including the lens group (i.e., light axis of plural lens are identical) 91 having the plural lens in the center therein may be provided on the inner part of the bottom portion 8a. The optical unit 9 is fixed with the illumination unit 8 by tightening members, for example a screw or the like, on the back surface of the illumination unit 8.

The optical unit 9 having the cubic configuration may be made of resin or the like. The optical unit 9 may be formed with a lens bore 92 arranged with the lens group 91 in the X-direction and two light source bores 93. Each marker light source 94 may be positioned in the optical bore 93 respectively. In this case, the light axis X of the lens group 91 and the CCD camera 95 may be identical.

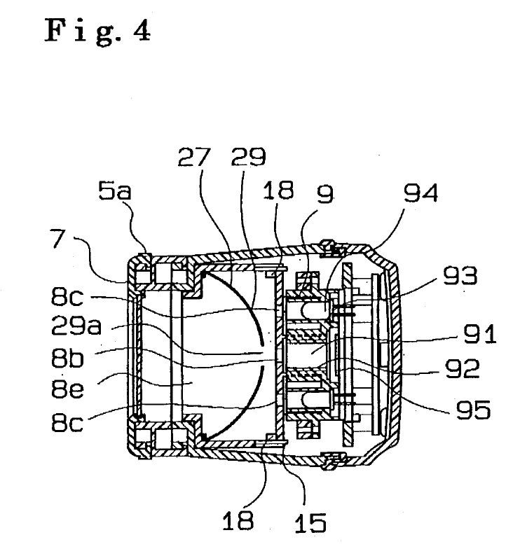

The back surface of the optical unit 9 may have a concave configuration as shown in FIG. 4. The CCD camera 95 having a CCD element therein may be provided in the concave portion. An optical board 11 mounted with the CCD camera 95 on the surface may be fixed to the optical unit 9 with tightening members, such as screws or the like (not shown), from the back surface of the optical board 11. The marker light source 94 for generating the light for indicating the reading position when reading the code from two positions may be attached to the optical board 11. The optical board 11 may be mounted with electronic parts, such as a chip shaped transistor, resistors, and a condenser for constructing a drive circuit and detection circuit of the CCD camera 95 and a driver circuit for driving the marker light source 94. The optical board 11 may be configured to illuminate the marker light source 94 and to output a detection signal regarding the code reading from the image imaged on the CCD element by driving the CCD camera 95. The optical board 11 may be connected with a harness configured to be electrically connected with a main board 21. The detection signal related to the code reader from the optical board 11 is transmitted to the main board 21, and the signal from the main board 21 drives the marker light source 94 and the CCD camera 95.

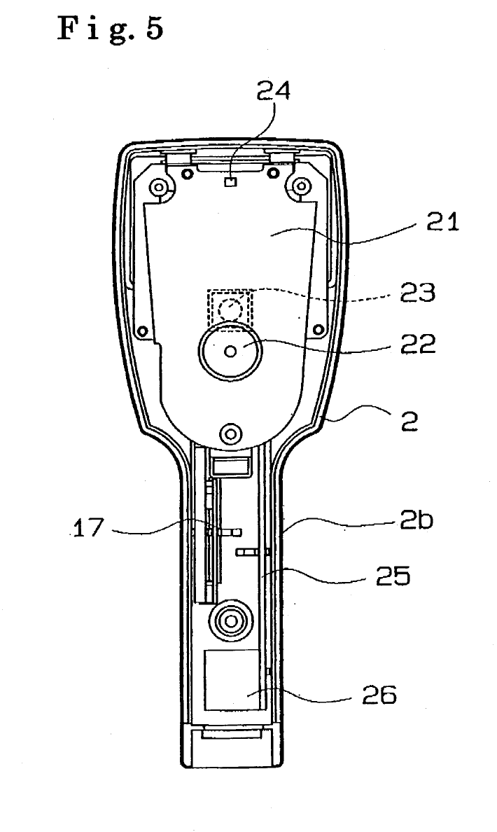

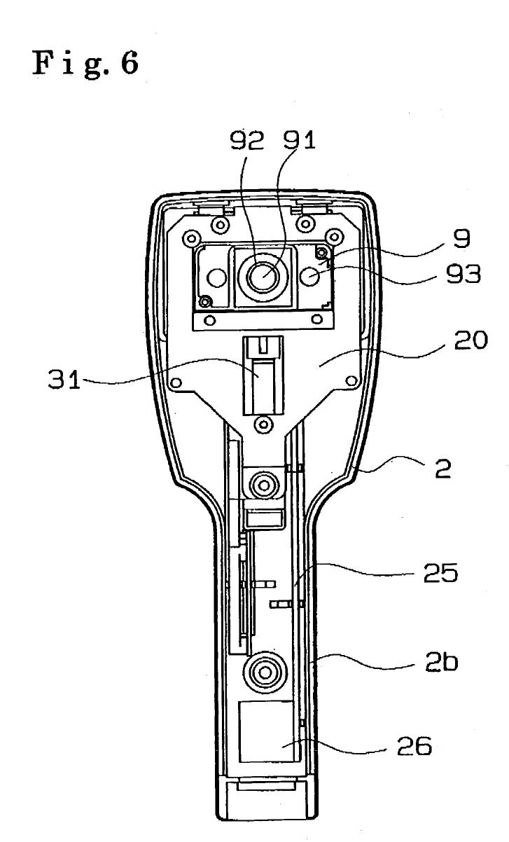

As shown in FIG. 5, the main board 21 is positioned on the most back surface of the housing 2 for controlling the code reading of the coder reader 1. A voltage buzzer 22 and a light source 24 for confirmation (i.e., green LED for confirmation) 24 for visually indicating the completion of the reading are mounted on the most back side of the main board 21 by soldering or the like. A contact switch 23 is mounted on the other side of the main board 21 by soldering or the like. Further, the main board 21 may include chip shaped electronic parts such as transistors, resistors, and condensers on both surfaces thereof and may include a decode circuit for decoding a detection signal by the CCD element from the optical board 11, a drive circuit for driving the voltage buzzer 22, and a drive circuit for driving the light source 24 for the confirmation for confirming the reading.

Further, a central processing unit (CPU) (not shown) for controlling the code reading of the code reader 1 and a memory (not shown) for tentatively storing the information regarding the code reading may be mounted on the surface of the main board 21 on an optical board side. The main board 21 may be electrically connected to the opposingly arranged optical board 11 via, e.g., a flat cable. In the main board 21, the code 10 read by the CCD camera 95 may be decoded by a decode circuit (not shown) therein. The decoded signal may be transmitted to an interface board 25 provided in the grip portion 2b shown in FIG. 2.

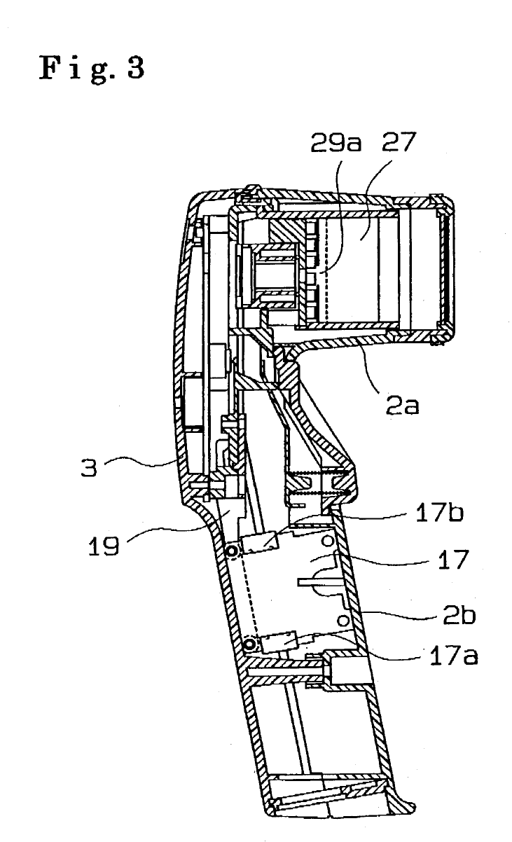

The signal for driving the light source 18 for the illumination provided in the illumination unit 8 may be driven by a light source drive board 17 for the illumination provided in the grip portion 2b as shown in FIG. 3. In this case, the light source drive board 17 for the illumination may be driven by the direction from the main board 21.

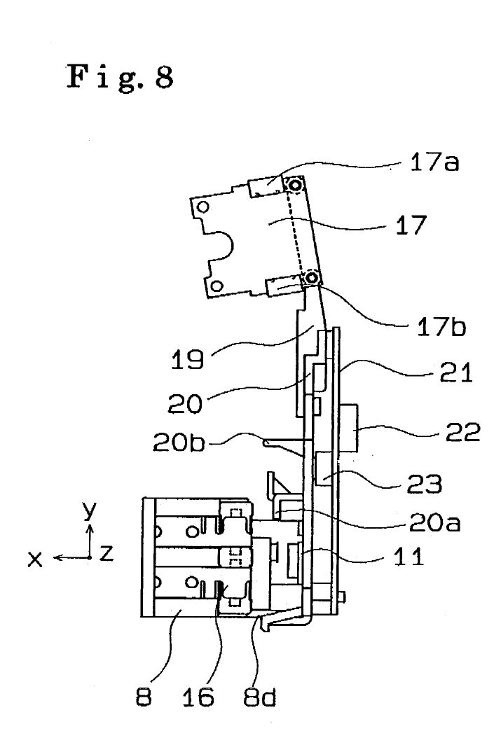

The main board 21, the optical board 11, the optical unit 9, and the illumination unit 8 are formed as one unit by, for example, a resin-made holder 20 as shown in the non-limiting illustration of FIG. 8. The holder 20 may be provided being positioned at a predetermined position of the first housing 2 from the back surface of the first housing 2 to be fixed to the first housing via four tightening members, such as screws or the like. The holder 20 may be extended in the Y-direction. A rectangular detent bore may be unitarily formed on the holder 20 on an end portion of the holder 20 corresponding to the top of the reader (i.e., bottom side in FIG. 8). An L-shaped craw portion 8d formed on the top of the reader of the illumination unit 8 may be detained in the detent bore. The position of the illumination unit 8 may be determined at a predetermined position of the holder 20. In order to contact the back surface of the illumination unit 8 to the holder 20 to fix thereon, an L-shaped mounting portion 20a for fixing the illumination unit 8 may be unitarily formed on the holder 20 on an end portion thereof, opposite to the craw portion 8d on an illumination unit top end. The tightening members, e.g., screws, may be applied to the mounting portion 20a from the back surface side of the holder 20 to fix the illumination unit 8 on the holder 20 on the reader topside.

One end of a holder 19 may be fixed to an end portion of the bottom side (i.e., top of FIG. 8) of the holder 20 via two tightening members such as screws or the like. The light source drive board 17 for driving the illumination having the driver circuit that may be mounted with the electronic parts such as the resistors and the transistors on the surface and for driving the light source 18 for the illumination may be fixed to the other end of the holder 19 with two tightening members, such as screws in the Y-direction as shown in FIG. 8. Thereafter, the light source drive board 17 for the illumination is positioned in the internal space of the grip portion 2b of the code reader 1 to be fixed to the housing 2 by the tightening members such as screws or the like on the X-Y surface. The light source drive board 17 for the illumination may include two connectors 17a, 17b on both end portions thereof in the Y-direction. The connector 17a may be connected to an external connector which may be connected to the main board 20 via a harness (not shown). Thus, a light source drive signal for driving the light source 18 for the illumination may be output from the main board 21 to drive the light source 18 based on the output signal.

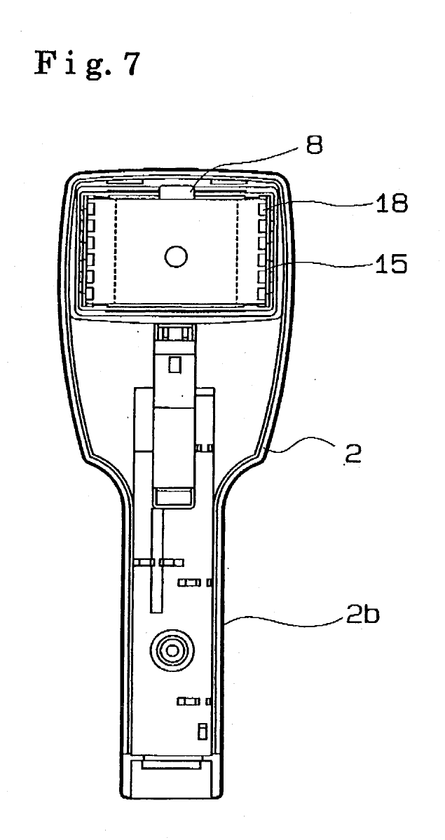

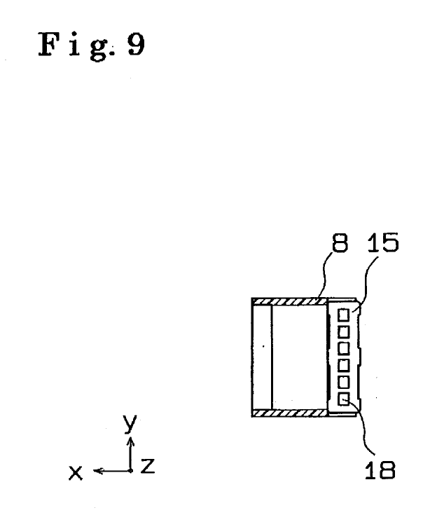

The construction of the light source 18 will be explained referring to FIGS. 4 and 9. As shown in FIG. 4, the illumination unit 8 may include an opening 8e configured to have narrower diameter than the space provided with the diffusion unit 8. The illumination unit 8 may be provided on the back surface of the reading portion 7 with concave-convex engagement. As shown in FIG. 7, light source boards 15 for illumination provided with the plural light sources 18 for the illumination (e.g., six for each side) are opposingly positioned on both sides in the Z-direction at the back surface position of the illumination unit 8. The light generated from the light source 18 for the illumination brightly illuminates the bore 8b functioning as the entrance pupil by contacting at the position of the bore 8b at the central portion in the Z-direction. Thus, because the bore 8b is brightly illuminated, the reflective light may enter via the bore 8b to be taken into the CCD element. On the other hand, because the diffusion member 27 may be provided between the reading portion 7 and the bore 8b in the X-direction, the light having a predetermined irradiating angle from the light source 18 for the illumination may permeate the curved diffusion sheet 29. In this case, the light that enters via the diffusion sheet 28 may be diffused to effectively illuminate the surface 32.

As shown in FIG. 8, electrically conductive terminals 16 may be connected to the light source 18 for the illumination. The terminals 16 are provided along a side surface of the illumination unit 8 in the Z-direction. Further, the electrically conductive terminals 16 may be electrically connected to the connector 17b of the light source drive board 17 for the illumination via a harness (not shown). Thus, by providing the light source drive signal from the main board 21, the light source 18 for the illumination may be turned on or flashed with a predetermined cycle when performing code reading.

On the other hand, a switch operation portion 20b may be projected in the X-direction on the middle portion of the holder 20 extended in the Y-direction. The switch operation portion 20b may be unitarily formed with the holder 20 while being movable in the X-direction. When the illumination unit 8 is unitarily provided (i.e., under subassembly state), the switch operation portion 20b may be projected in the X-direction perpendicularly from the holder 20 as shown in FIG. 8. With the foregoing construction, the contact switch 23 may be pushed by the back surface of the switch operation portion 20b when the switch operation portion 20b is operated. Thus the turning on and off the contact switch 23 may be performed. In this case, the code 10 may be read by the code reader 1 when the contact switch 23 is ON and the reading of the code 10 is prohibited when the contact switch 23 is OFF.

The operation of the operation lever 31 will be explained as follows. When the user grabs the grip portion 2b, the operation lever 31 may be operated using a finger. The operation lever may be pushed to rotate in the counterclockwise direction of FIG. 2 about a fulcrum 31b positioned around a base of the hood portion 2a. In this case, the code reader 1 may be formed with a recess portion 2c having a surface extended in the Y-direction on a portion of the housing 2 opposite the operation lever 31 so that the operation lever 31 becomes rotatable at the operation. A projection 2d projecting in the X-direction may be formed unitarily on a portion of the recess portion 2c of the housing 2.

Alternately, a concave portion 31a for detaining one end of a spring 13 may be formed on a back surface corresponding to the projection 2d of the operation lever 31. The spring may be provided between the concave portion 31a formed on the operation lever 31 and the projection 2d formed on the housing 2. A flange 31c extended in the Y-direction may be unitarily formed on the operation lever 31 on an end portion opposite to the fulcrum 31b of the operation lever 31. The flange 31c may extend along the configuration of the grip portion 2b from the grip portion 2b of the housing 2.

The rotation of the operation lever 31 may be restricted by a restriction portion 2f covering a portion of the concave portion 2c of the housing 2. Thus, the operation lever 31 may be rotated until the back surface of the operation lever 31 contacts an apex of the projection 2d when the operation lever 31 is rotated in the counterclockwise direction (shown in FIG. 2) about the fulcrum 31b against the biasing force of the spring 13. The switch contact portion 20b may contact the back surface. When the operation lever 31 is operated to rotate the operation lever 31 in the counterclockwise direction, the switch operation portion 20b is pushed. Accordingly, the contact switch 23 is turned on and the switch signal from the contact switch 23 is input into the CPU of the main board 21.

On the other hand, when a force is not applied to the operation lever 31 after operation thereof, the operation lever 31 is rotated in the clockwise direction of FIG. 2 about the fulcrum 31b by the biasing force of the spring 13. Thereafter, the flange 31c formed on one end of the operation lever 31 may contact the restriction portion 2f of the housing 2 to restrict the further rotation of the operation lever 31 in the clockwise direction. As earlier described, when the rotation of the operation lever 31 in the counterclockwise direction is canceled, the pushing pressure to the contact switch 23 by the switch operation portion 20b is canceled. Thus, the contact switch 23 becomes OFF and the switch signal thereof is input into the CPU.

The connection between the code reader 1 and external device 40 will be explained as follows. As shown in the non-limiting illustration of FIG. 5, the interface board (i.e., I/F board) 25 may be fitted into a slit formed on a back surface of the housing 2 to be mounted opposing the drive board 17, while keeping a predetermined distance relative to the driver board 17 in the grip portion 2b of the code reader 1. The interface board 25 may be electrically connected to the main board 21 via a cable (e.g., a flat cable, a harness or the like, not shown). A connector 26 may be fixed to an end of the I/F board 25 on the bottom portion of the reader. The I/F board 25 also includes a power source circuit for supplying a constant direct current (e.g., 5V) relative to the plural boards of the code reader 1 therein. A circuit on the I/F board 25 supplies a stable predetermined power (e.g., 5V) to the main board 21. In case the external connector is connected to the connector 26, the data of the signal (e.g., decoded signal of the code 10 detected by the CCD camera 95) regarding the reading of the code may be sent to and received by the external device (e.g., code control device having the display function or the code analysis device) 40 connected via the connector 26. With the foregoing construction, for example, the reading signal of the code 10 decoded from a decode circuit may be output from the external device 40 to the code reader 1 and the reading signal may be sent to the external device 40.

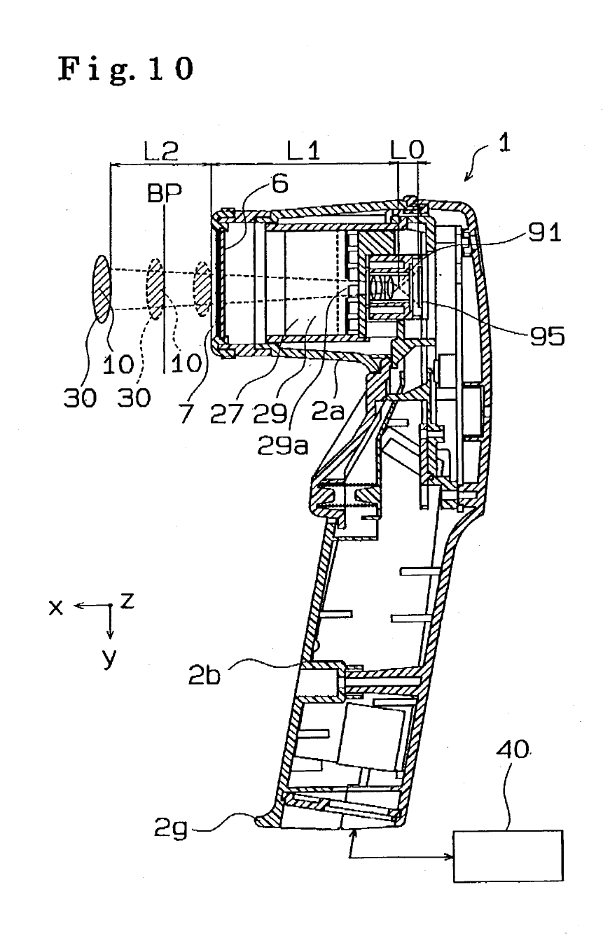

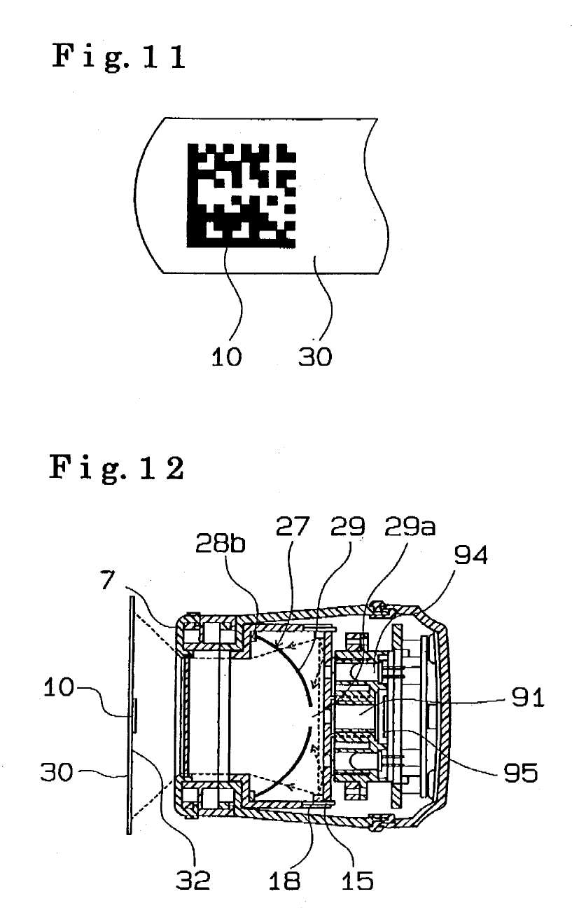

The operation of the code reader 1 will be explained with reference to FIG. 10 as follows. The code reader 1 enables reading of the code 10 by directly contacting the reading portion 7 to the object 30 provided with the code or the code 10 indicating the two-dimensional unique information and by keeping a distance from the surface 32 to be read without contacting the code 10 or the object 30 provided with the code 10.

The user performing the reading of the code 10 holds the grip portion 2b of the code reader 1 and positions the code reader 1 at the position that the reading portion 7 is over the two-dimensional code 10. When the user pulls the operation lever 31 against the biasing force of the spring 13 from this position, the operation lever 31 rotates about the fulcrum 31b in the counterclockwise direction (shown in FIG. 2). By this operation, the switch operation portion 20b may be pushed by the back surface of the operation lever 31. Accordingly, the switch operation portion 20b may move in the X-direction, the contact switch 23 provided on the back surface of the switch operation portion 20b is pushed by the movement of the switch operation portion 20b to be in the ON state. When the contact switch 23 is ON, the signal indicating the ON state of the contact switch 23 may be recognized as a trigger for starting the reading by the CPU (not shown) in the main board 21. The information indicated by the code 10 may be read in the foregoing manner.

The main board 21 is configured to simultaneously output the drive signal for driving the indirect light source 18 for the illumination and the marker light source 94 to the light source drive board 17 for the illumination and the optical board 11 under the state that the contact switch 23 is ON. With the drive signal for driving the light sources, the light source 18 for the illumination opposingly positioned in the illumination unit 8 may be flashed either simultaneously or with a predetermined cycle. The flashed light from the light source 18 for the illumination on both sides contact at the position of the bore 8b functioning as the entrance pupil to brightly illuminate the bore 8b and a part of the light having the predetermined irradiation angle is entered into the diffusion sheet 29. The light entered into the diffusion sheet 29 (i.e., a part of the red light having the predetermined irradiation angle or the light reflected on an inside surface having a camouflaged color or mirror surface or the like of the illumination unit 8) is effectively diffused by the diffusion sheet 29, preferably having permeability of about 75-85 percent. As shown in FIG. 12, the light may be introduced to the reading portion 7, and may be irradiated on the surface 32.

Accordingly, by permeating the light through the diffusion sheet 29 of the diffusion member 27, a predetermined amount of the diffusion light which is not a high amount of light is generated to brightly illuminate the surface 32 to be read. In this case, simultaneously, the main board 21 may drive the marker light source 94 provided on both sides of the CCD camera 95. The red light generated from the marker light source 94 may pass through the slit bores 8c formed on the bottom portion 8a of the illumination unit 8, may pass through the diffusion sheet 29, and may be irradiated on the surface 32 to be read to be utilized for positioning relative to the object 30 provided with the code 10. When the positioning of the code reader 1 relative to the code 10 is performed by the light from the marker light source 94 so that the code reading may be performed, the light contacting the code 10 may be reflected depending on the condition of the code 10 (e.g., condition of the darkness or the condition of the roughness of the surface) and may enter into the bore 8b on the central portion of the illumination unit 8 (functioning as the entrance pupil via the bore 29a provided on the central portion of the diffusion sheet 29). The light that enters the bore 8b may be imaged on the CCD element of the CCD camera 95 via the lens group 91. The signal detected by the CCD element of the CCD camera 95 may thereafter be transmitted to the main board 21.

In the main board 21, the detected signal may be decoded based on the strength of the reflective light by a decode circuit therein and the decoded signal may be transmitted to the I/F circuit 25. Further thereafter, the decoded signal may be transmitted to the external device 40 from the connector 26 provided on the I/F circuit 25. The external device 40 may control the plural objects 30 by displaying the read two dimensional code 10 and by analyzing the information indicated by the code 10 based on the signal detected by the CCD camera 95.

The reading distance in terms of the optical of the code reader 1 will be explained referring to FIG. 10.

The CCD camera 95 may be fixed on the optical board 11 assembled on the back surface of the optical unit 9. With the construction shown in FIG. 10, the light axis X of the CCD camera 95 and the light axis X of the lens group 91 including the plural lens therein may be identical. Provided that a distance between the CCD camera 95 and a camera focus point Pf is determined as a distance L0 and a distance between the focus point Pf and a tip end of the reading portion 7 is determined as a distance L1, an adjusting member 12 is provided between the hood portion 2a and the hood cover 5 for maintaining a light permeable board 6 functioning as the optical filter so that the distance L1 corresponds to a minimum recognition distance for recognizing the object to be read (i.e., two-dimensional code) on the surface to be read and for imaging the image on the CCD element of the CCD camera 95. Thus, the code may be read even when the reading portion 7 directly contacts the code 10 because the recognizable distance of the CCD camera 95 corresponds to the minimum recognition distance L1. In other words, the reading operation of the code reader 1 may be easily performed by the user who is not familiar with the operation thereof by contacting the reading surface of the code reader 1 on the code 10.

In this case, by slightly projecting an end portion 2g of the grip portion 2b of the code reader 1 in the X-direction, the reading operation of the code 10 may be performed only by the operation of the operation lever 31 without holding the code reader 1 while contacting both the end portion 2g of the grip portion 2b and the end portion of the reading portion 7 to either to the object 30 or a base provided with the object 30. Even when the reading operation is performed by keeping a predetermined distance between the reading portion 7 and the code 10, the image capturing may be performed by the CCD camera 95 by generating the diffusion light by the light transmission member 27 before entering the reflection light to the CCD camera 95 in the illumination unit 8. Thus, for example, even when the code 10 is provided on the object with a mirror surface, the reading may be performed without causing the saturation of the CCD element by providing the light transmission member 27 between the CCD camera 95 and the reading portion 7, because the strength of the reflective light is saturated up to a predetermined level by the reflective light.

With the code reader 1 according to the non-limiting first embodiment of the present invention, when reading is performed keeping the distance between the code 10 and the coder reader 1 constant, because the positional relationship with the camera focus point is determined with the minimum recognition distance L1, one of zero points in the recognition range by CCD element is to be determined. Thus, a recognizable region L2 can be maximally obtained to a position of the maximum recognition distance, which makes the recognition of the code 10 easy during the operation. In this case, an optimum focus position BP is positioned between the minimum recognition distance and the maximum recognition distance (at an intermediate position between the minimum recognition distance and the maximum recognition distance).

When the accurate reading operation of the code 10 is performed by the code reader 1, the alarm noise of the voltage buzzer 22 may be sounded and the light source 24 for confirmation generating the green light may be turned on by the main board 21 when the accurate reading operation is performed by the code reader 1. Likewise, by audibly informing with the voltage buzzer 22 and by visually informing by driving the light source 24 for confirmation, the user can easily recognize that the code reader 1 has accurately read the code 10.

Although the diffusion sheet 29 having an even membrane thickness may be applied for diffusing the light generated from the light source 18 for the illumination with the first non-limiting embodiment of the code reader of the present invention, the configuration of the diffusion sheet is not limited. For example, the thickness of the diffusion sheet may be gradually varied from the end portion 28b to the bore 29a on the central portion (e.g., the thickness may decrease). With this construction of the diffusion sheet having gradually varied thickness, the even diffusion light may be generated by passing the light through the diffusion sheet. In other words, the diffusion sheet 29 may be thinner when the light source 18 is further from the diffusion sheet 29. By making the portion of the diffusion sheet thinner where the light from the light source 18 is weak, even diffusion light may be created with a simple construction.

Further, with the non-limiting first embodiment of the code reader of the present invention, the adjusting member 12 having the hood cover 5 may be configured to be removable from the housing 2. In case the adjusting member 12 is removed from the housing 2, the opening 8e of the illumination unit 8 provided in the housing may be exposed. Thus, when providing the diffusion member 27 shown in FIG. 13 to create the even diffusion light in the illumination unit 8, the diffusion sheet 29 may be accommodated in the sheet frame via the insertion opening 28a along the guiding surface formed in the sheet frame 28. Then, by inwardly bending the both end portions 28b of the sheet frame 28, the diffusion member 27 may be inserted into the internal space of the illumination unit 8 via the opening 8e to be provided therein.

In this case, the diffusion member 27 may be positioned with a stopper (not shown) formed on a predetermined position on an internal surface of the illumination unit 8. With the foregoing construction, the diffusion member 27 can be accommodated in the illumination unit 8 via the opening 8e by removing the reading portion 7 of the code reader 1 from the hood portion 2a of the housing 2 along with the adjusting member 12. Accordingly, the diffusion member 27 can be replaced via the opening 8e in case it is desired to change the permeability of the diffusion sheet 29 to the desired permeability or when it is required to exchange the diffusion sheet 29 due to wear and tear.

In this case, the lip 28c provided on the end portions 28b of the sheet frame 28 makes it easy to exchange the diffusion member 27 because the user can pinches the lip 28c for exchanging the diffusion sheet 29.

Further, although the diffusion member 27 includes a curved configuration in the non-limiting first embodiment of the present invention, the configuration of the diffusion member is not limited. For example, the diffusion member may be configured to be in parallel to the bottom portion 8a of the illumination unit 8. By configuring the diffusion member 27 to be in parallel to the bottom portion 8a of the illumination unit 8, the diameter of the bore 29a can be determined in accordance with the minimum distance Lb between the bore 29a configured to enter the reflective light contacting the unique code 10 and the bottom portion 8a of the diffusion sheet 29 (i.e., the minimum distance Lb is determined to be proportional to the diameter of the bore 29).

According to the non-limiting first embodiment of the code reader of the present invention, even when the illumination means are opposingly positioned, the diffusion light can be irradiated on the surface to be read by refracting the light from the illumination means by the diffusion member. By the refraction of the light when passing through the diffusion member, the irradiation angle of the light relative to the surface to be read can be expanded and the surface to be read can be brightly illuminated by the diffusion light. Because the luminance of the reflective light reflecting by contacting the unique code is relatively improved, the code recognition becomes easier.

By configuring the diffusion member to have the bore being entered with the reflective light and have the curved shape, the reflective light reflected from the unique code is entered through the core provided on the diffusion member. Because the reflective light whose luminance is not attenuated is entered into the entrance pupil via the bore, the code recognition performance is improved.

Further, by gradually varying the thickness of the diffusion member to be thinner as closer to the bore, additional even diffusion light can be generated.

With the code reader according to the first non-limiting embodiment of the present invention, the illumination means and the diffusion member are provided in the housing, the illumination unit includes the opening, the reading portion is detachable from the housing, and the diffusion member can be inserted to be accommodated in the illumination unit via the opening. In case the illumination unit including the illumination means and the diffusion member are provided in the housing, the reading portion can be removed from the housing to insert the diffusion member in the illumination unit via the opening to accommodate, and the diffusion member can be removed-to be exchanged via the opening.

By providing the mirror surface or camouflaged color for reflecting the light from the illumination means on the internal surface of the illumination unit, the light from the illumination means can be effectively reflected on the internal surface including either the mirror surface or the camouflaged color.

Because the diffusion member includes the diffusion sheet and the protection frame for protecting the surrounding of the diffusion sheet, the diffusion member can be assembled in the illumination unit via the protection frame.

Because the diffusion sheet can be detachable in the protection frame, it is possible to exchange the diffusion sheet by itself. In case the permeability of the diffusion sheet is required to be changed, the diffusion sheet can be replaced with a diffusion sheet with the predetermined permeability.

By forming the lip on the protection frame, the disassembling and the assembling to be accommodated of the diffusion member from and to the illumination unit can be performed using the lip.

A second embodiment of the code reader will be explained referring to FIG. 14. The code reader of the second embodiment includes the diffusion member 27 including a diffusion sheet 50 having a permeable portion 50a facing the entrance pupil 8b for lineally permeating the light when the light permeates and a diffusion portion 50b having a function for diffusing the light surrounding the permeable portion 50a. The permeable portion 50a may be filled with a material for fully permeating the light such as vinyl sheet, or the like. With this construction, by lineally permeating the light entering into the diffusion sheet 50 when the light permeates the diffusion sheet 50 at the portion facing the entrance pupil 8b, the image without distortion can be imaged by the CCD camera. The diffusion sheet 50 may be made by applying or pasting the diffusion member, for example, a bead coat layer, on the sheet member made of such as transparent glass, plastic, resin, or the like, while avoiding at least the portion facing the entrance pupil 8b. Transparent member such as glass, plastic, resin, or the like may be injected into the bore formed in the central portion of the diffusion member.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A code reader comprising:
a housing;
a reading portion, provided at the housing, for reading a code provided on an object;
plural illumination means, provided at the housing, for illuminating a surface to be read;
an image capturing means, provided at the housing, for capturing an image of the code, the image capturing means including an entrance pupil through which light reflected from the surface to be read enters;
means for diffusing the irradiated lights;
wherein at least two of the plural illumination means are positioned opposite each other relative to the entrance pupil, and
the means for diffusing is positioned between the illumination means and the reading portion.

2. A code reader according to claim 1, wherein the means for diffusing includes a bore, thereby enabling the reflected light to enter the entrance pupil.

3. A code reader according to claim 1, wherein the means for diffusing is provided at the housing such that a minimum distance between the means for diffusing and the entrance pupil is shorter than a minimum distance between the means for diffusing and the illumination means.

4. A code reader according to claim 3, wherein the means for diffusing has a varying thickness that gradually becomes thinner at a position closer to a bore formed on the diffusion member.

5. A code reader according to claim 1, further including an illumination unit including an opening, the illumination means, and the means for diffusing,
wherein the reading portion and the means for diffusion are detachable.

6. A code reader according to claim 5, wherein the illumination unit includes an internal surface having a camouflaged color for reflecting the light from the illumination means.

7. A code reader according to claim 1, wherein the means for diffusing includes a diffusion sheet and a protection frame for protecting a periphery of the diffusion sheet.

8. A code reader according to claim 7, wherein the protection frame is configured to be attached to the diffusion sheet.

9. A code reader according to claim 5, wherein the protection frame includes a lip.

10. A code reader according to claim 5, wherein the opening is configured to be smaller than a space in the illumination unit provided with the means for diffusing.

11. A code reader according to claim 1, wherein the means for diffusing permeates the light in a linear direction at least at a portion facing the entrance pupil.

12. A code reader according to claim 1, wherein the means for diffusing includes a permeable portion facing the entrance pupil.

13. A code reader comprising:
a housing;
a reading portion, provided at the housing, for reading a code provided on an object;
plural light sources, provided at the housing, configured to irradiate light to a surface to be read;
a CCD camera, provided at the housing, configured to capture an image of the code via an entrance pupil provided in the housing;
a diffusion member configured to permeate and diffuse the light from the light source and to irradiate the diffused light to the surface to be read,
wherein at least two of the plural light sources are positioned opposite to each other relative to the entrance pupil; and
the diffusion member is positioned between the light source and the reading portion.

14. A code reader according to claim 13, wherein the diffusion member includes a bore, thereby enabling the reflected light to enter the entrance pupil.

15. A code reader according to claim 13, wherein the diffusion member is provided at the housing such that a minimum distance between the diffusion member and the entrance pupil is shorter than a minimum distance between the diffusion member and the light source.

16. A code reader according to claim 15, wherein the diffusion member includes a thickness that gradually becomes thinner closer to the bore formed on the diffusion member.

17. A code reader according to claim 13, further including an illumination unit including an opening, the light source, and the diffusion member,
wherein the reading portion is detachable from the housing and the diffusion member can be inserted into and removed from the illumination unit via the opening.

18. A code reader according to claim 17, wherein the illumination unit includes an internal surface having a camouflaged color for reflecting the light from the light source.

19. A code reader according to claim 13, wherein the diffusion member includes a diffusion sheet and a protection frame configured to protect a periphery of the diffusion sheet.

20. A code reader according to claim 17, wherein the protection frame includes a lip.

21. A code reader according to claim 13, wherein the diffusion member is configured to permeate the light in a linear direction at least at a portion facing the entrance pupil.

22. A method for reading a code, comprising:
using a code reader, comprising:
a housing;
a reading portion, provided at the housing, for reading a code provided on an object;
plural light sources, provided at the housing, configured to irradiate light to a surface to be read;
a CCD camera, provided at the housing, configured to capture an image of the code via an entrance pupil provided in the housing;
a diffusion member configured to permeate and diffuse the light from the light source and to irradiate the diffused light to the surface to be read,
wherein at least two of the plural light sources are positioned opposite to each other relative to the entrance pupil; and
the diffusion member is positioned between the light source and the reading portion.
